(19) United States
(12) Patent Application Publication
(10) Pub. No.: US 2009/0038147 A1
(43) Pub. Date: Feb. 12, 2009

(54) MANUFACTURING PROCESS AND FIXTURE FOR AN ELECTRICAL TERMINAL

(76) Inventor: Ronald G. Ungerer, Avilla, IN (US)

Correspondence Address: TAYLOR & AUST, P.C., P.O. Box 560, 142. S Main Street, Avilla, IN, 46710, US

(21) Appl. No.: 12/187,425

(22) Filed: Aug. 7, 2008

Related U.S. Application Data
(60) Provisional application No. 60/954,383, filed on Aug. 7, 2007.

(51) Int. Cl. H01R 43/20; H01R 43/00

(52) U.S. Cl. 29/748; 29/876; 29/747; 29/844

(57) ABSTRACT

A method of manufacturing a plurality of electrical terminals includes the steps of: providing an electrical terminal manufacturing fixture which includes a main body defining a plurality of stations; loading the fixture with a plurality of metal workpieces each formed as a tube; and moving the workpieces, one after another, sequentially forward through the stations and thereby transforming each workpiece into two of the electrical terminals.

### CROSS REFERENCE TO RELATED APPLICATIONS

This is a non-provisional application based upon U.S. provisional patent application Ser. No. 60/954,383, entitled “MANUFACTURING PROCESS AND FIXTURE FOR AN ELECTRIAL TERMINAL”, filed Aug. 7, 2007, which is incorporated herein by reference.

### BACKGROUND OF THE INVENTION

1. Field of the Invention

The present invention relates to an automated manufacturing process for continuously manufacturing electrical terminals.

2. Description of the Related Art

Electrical terminals may be manufactured by stamping sheet material and subsequently bending the sheet material along predefined fold lines to define the terminal. Crimped terminals typically include a split ferrule at one end which is placed over a conductor and crimped to hold the terminal in place. The conductor is usually an insulated conductor, and may form part of a distribution harness, such as used in the automotive industry.

What is needed in the art is a manufacturing method and fixture which allows electrical terminals to be manufactured in a continuous manner, with decreased manpower.

### SUMMARY OF THE INVENTION

The present invention provides a manufacturing method and fixture which allows electrical terminals to be manufactured in a continuous manner, with decreased manpower.

The invention in one form is directed to a method of manufacturing a plurality of electrical terminals. The method includes the steps of: providing an electrical terminal manufacturing fixture which includes a main body defining a plurality of stations; loading the fixture with a plurality of metal workpieces each formed as a tube; and moving the workpieces, one after another, sequentially forward through the stations and thereby transforming each workpiece into two of the electrical terminals.

The invention in another form is directed to an electrical terminal manufacturing fixture for manufacturing a plurality of electrical terminals. The fixture includes a main body defining a plurality of stations. The fixture is configured for being loaded with a plurality of metal workpieces each formed as a tube and for moving the workpieces, one after another, sequentially forward through the stations and thereby transforming each workpiece into two of the electrical terminals.

An advantage of the present invention is that it produces electrical terminals with decreased manpower.

Another advantage of the present invention is that it produces electrical terminals by advancing the workpiece in a direction which is perpendicular to the longitudinal axis of the workpiece.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of the electrical terminal manufacturing fixture and method of the present invention, without the stamps of the second, third, and sixth stations;

FIG. 2 is a schematic view of the manufacturing fixture of FIG. 1, with stamps of the second, third, and sixth stations;

FIG. 3 is a perspective view of the workpiece which is supplied to the supply ramp of the manufacturing fixture of FIG. 1;

FIG. 4 is a top view of the electrical terminal formed by the manufacturing fixture of FIG. 1;

FIG. 5 is a side view of the electrical terminal formed by the manufacturing fixture of FIG. 1;

FIG. 6 is a schematic top view of the manufacturing fixture and method of FIG. 1 with portions broken away;

FIG. 7 is a schematic top view of the manufacturing fixture and method of FIG. 1 with portions broken away;

FIG. 8 is a schematic side view of the manufacturing fixture and method of FIG. 1 with portions broken away;

FIG. 9 is a schematic end view of the manufacturing fixture and method of FIG. 1 with portions broken away;

FIG. 10 is a schematic end view of the manufacturing fixture and method of FIG. 1 with portions broken away;

FIG. 11 is a schematic side view of another embodiment of the manufacturing fixture and method of the present invention, with portions broken away;

FIG. 12 is a schematic, exploded, top view of yet another embodiment of the manufacturing fixture and method of the present invention, with portions broken away;

FIG. 13 is a schematic, exploded, top view of the manufacturing fixture and method of FIG. 12, with portions broken away; and

FIG. 14 is a schematic, exploded, top view of the manufacturing fixture and method of FIG. 12, with portions broken away.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

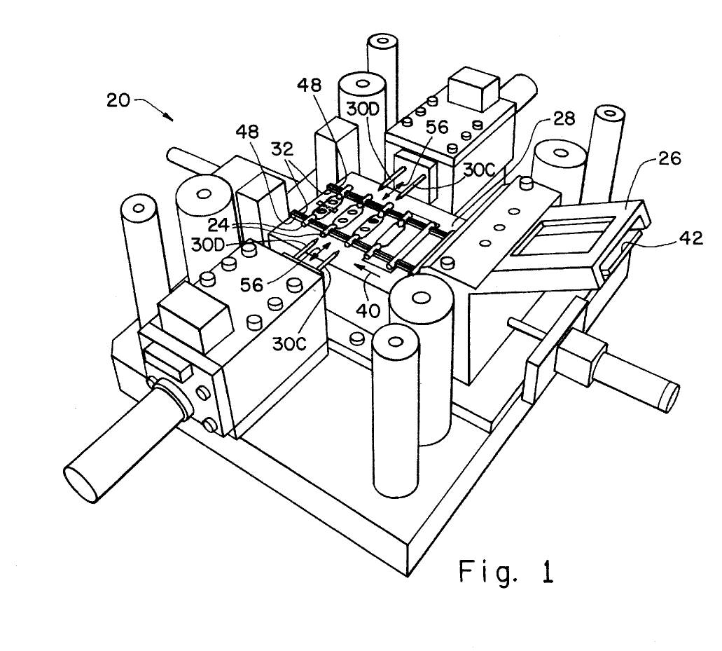

Referring now to the drawings, and more particularly to FIG. 1-10, there is shown a first embodiment of an electrical terminal manufacturing fixture 20 and method for manufacturing a plurality of electrical terminals 22. Fixture 20, which transforms one metal workpiece 24 into two electrical terminals 22, generally includes a supply ramp 26, a main body 28, a plurality of forming devices 30, and an incrementing slide 32. Fixture 20 is configured for being loaded with a plurality of metal workpieces 24 each formed as a tube 24 and for moving workpieces 24, one after another, sequentially forward through a plurality of stations 1, 2, 3, 4, 5, and 6, and thereby transforming each workpiece 24 into two electrical terminals 22. Fixture 20 is configured for continuously feeding the workpieces 24 through fixture 20.

Stated generally, the present invention provides a water tight electrical terminal 22. Pieces of copper tubing 24 are continuously fed through the machine 20. After the punches stamp the copper tubing 24, independent slide 32 rises, picks up tubing 24 by ends 34, and moves forward one position. Then slide 32 lowers and places copper piece 24 in the next station. Slide 32 moves back and the punches stamp again. This process continues and produces two terminals 22 each time slide moves forward. The present invention thus produces electrical terminals 22 with very little scrap and requires only a single person to both load the copper tubing 24 and bag the finished product. This process takes the human element out of the movement of the workpiece 24 to each station, while conventional manufacturing processes require seven people.

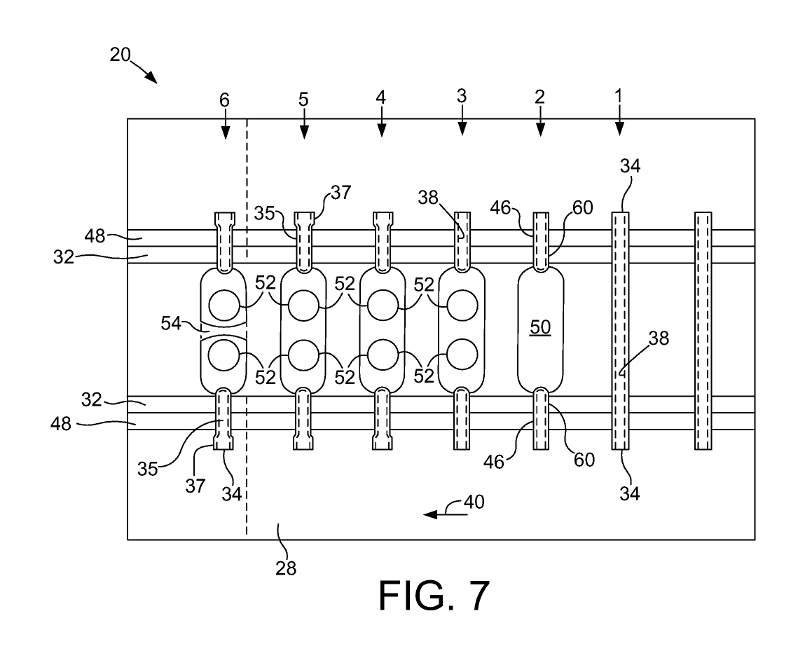

Each metal workpiece 24 is copper tubing 24 and is precut to length before being supplied to supply ramp 26. Each workpiece 24 has two opposing longitudinal ends 34. As tubing, each workpiece is cylindrical in shape, has a longitudinal axis 36, and has a hollow bore 38 running from one longitudinal end 34 to the opposing longitudinal end 34. Longitudinal axis 36 is positioned about the radial center of workpiece 24, as shown in FIG. 3. FIG. 3 shows workpiece 24 before workpiece 24 has been formed by fixture 20. The broken lines in workpiece 24 show bore 38. For instance, FIG. 7 shows workpiece 24 at station 1 with broken lines running through workpiece 24 from one longitudinal end 34 to the opposing longitudinal end 34; as such, bore 38 is a through-bore at station 1, as well as when workpiece 24 is supplied to supply ramp 26. FIG. 7 shows workpiece 24 at stations 2-6 after center portion 50 has been flattened; the broken lines in bridges 35 and conductor crimping sections 37 also show bore 38; however, after center section 50 has been flattened, bore 38 is a blind bore. Each tube 24 can be precut to a length of two and one-half inches prior to being supplied to supply ramp 26. Each workpiece 24 is fed from supply ramp 26 directly to slide 32 via gravity.

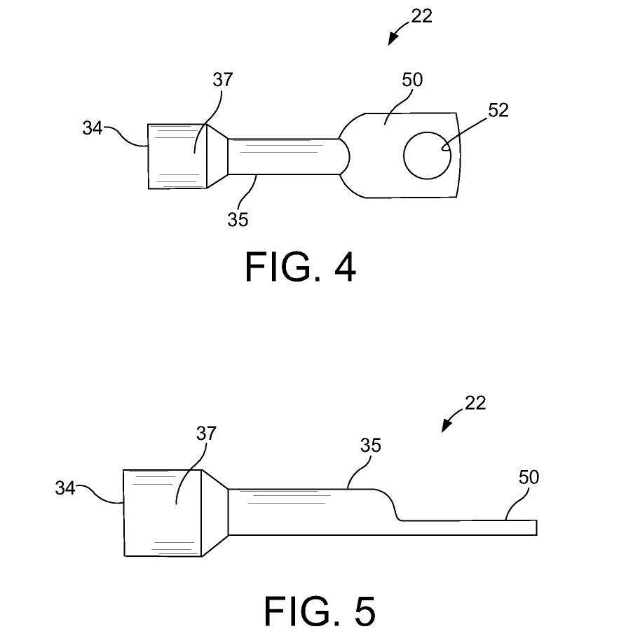

FIGS. 4 and 5 show the finished electrical terminal 22 which has been manufactured by fixture 20 and the method of the present invention. As indicated herein relative to workpiece 24, terminal 22 has a longitudinal end 34, a flat portion 50, and a through-hole 52 in flat portion 50. Terminal 22 further includes a bridge 35 and a conductor crimping section 37. Bridge 35 is generally cylindrical in shape and has blind bore 38 therein. Conductor crimping section 37 serves to crimp an electrical conductor (not shown) to terminal 22.

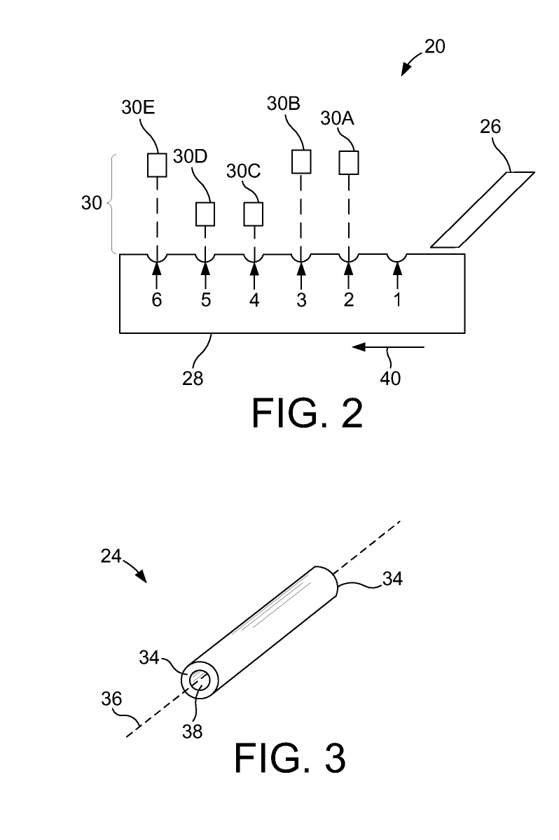

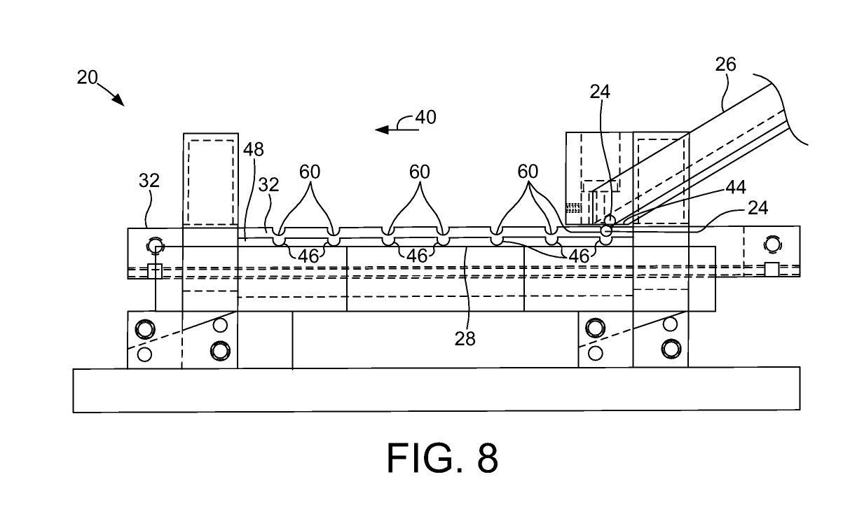

Supply ramp 26 is configured for being loaded with several of the tubular workpieces 24 and for feeding each workpiece 24 via gravity, directly or indirectly, to station 1 of main body 28. Supply ramp 26 is angled relative to main body 28; that is, while main body 28 is generally horizontal, supply ramp 26 can be angled from the horizontal so that workpieces 24 tend to move toward main body 28 under the influence of gravity. As shown in FIG. 8, supply ramp indirectly feeds each workpiece, one after the other, to station 1 in the sense that the respective workpiece 24 is fed from supply ramp 26 to slide 32, which then moves workpiece 24 to station 1 of main body 28. Alternatively, fixture 20 can be designed such that supply ramp 26 directly feeds each workpiece 24, one after the other, to station 1 in the sense that the workpiece 24 is fed from supply ramp 26 to station 1 without first being intercepted or moved by incrementing slide 32. Supply ramp 26 holds workpieces 24 such that longitudinal axis 36 of workpiece 24 is perpendicular to a direction of advance 40 of workpieces 24 through fixture 20 (this orientation is explained further below). Supply ramp 26, as shown in FIG. 2, can have an inlet 42 for receiving each workpiece 24 from an operator and an outlet 44 for depositing, in automated fashion, each workpiece 24, one at a time, on slide 32 for movement to station 1. Further, supply ramp 26 can include a roof (with a cutout so that an operator can observe and manipulate as necessary workpieces 24 in supply ramp 26) and a platform on which workpieces 24 rest, roof and platform forming a space therebetween in which the workpieces 24 are somewhat loosely captured as they slide, roll, and/or otherwise move from inlet 42 to outlet 44.

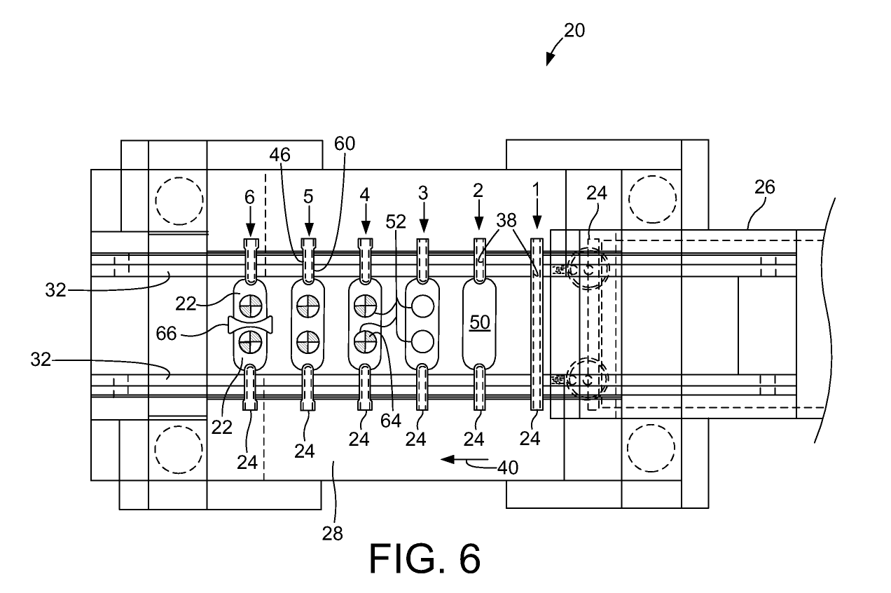

Main body 28 defines stations 1, 2, 3, 4, 5, and 6, at least one forming operation being performed at stations 2 through 6. Main body 28 defines direction of advance 40 in which workpieces 24 are moved forward, one after the other, sequentially through the stations 1-6. Direction of advance 40 is perpendicular to longitudinal axis 36 of each workpiece 24 when workpieces 24 are moved respectively forward through the stations 1-6. Thus, the tubes 24 are not advanced through the stations 1-6 in an end-to-end fashion; stated another way, the tubes 24 do not advance through the stations 1-6 such that longitudinal axis 36 of each tube 24 is parallel to direction of advance 40. Further, tubes 24 are not supplied to fixture 20 as one long tube that has a longitudinal axis which at least initially is parallel to direction of advance 40. Further, the tubes 24 are not supplied to fixture 20 as one long tube which must be cut into smaller workpieces prior to being formed at stations 1-6. As such, each tube 24 is supplied to supply ramp 26, remains in supply ramp 26 until released therefrom, and moves through each station 1-6 with longitudinal axis 36 of each tube 24 being perpendicular to direction of advance 40. Further, main body 28 can define a pair of spaced-apart notches 46 at each station 1, 2, 3, 4, 5, and 6. Notches 46 can be formed in upstanding walls 48 of main body 28, upstanding walls 48 running parallel to one another and to the direction of advance 40. Each notch 46 holds a corresponding longitudinal end 34 of the respective workpiece 24 until slide 32 removes workpiece 24 therefrom. When six stations 1, 2, 3, 4, 5, and 6 are used, main body 28 has at least six pairs of notches 46, two pairs of notches 46 being at each station, as shown in FIGS. 6, 7, and 8.

The stations of main body 28 includes a first station (station 1), a second station (station 2), a third station (station 3), a fourth station (station 4), a fifth station (station 5), and a sixth station (station 6). Using slide 32, each workpiece 24 moves, one after the other, sequentially through stations 1 through 6. That is, a respective workpiece 24 first goes to station 1, then to station 2, then to station 3, then to station 4, then to station 5, and then to station 6. Each station 1-6 is occupied by only one workpiece 24 at a time. To increase through-put and to maintain continuous feeding of the workpieces 24 through fixture 20, when the first workpiece 24 occupies station 2, a second workpiece 24 (the workpiece 24 following directly after the first workpiece 24) occupies station 1. Similarly, when the first workpiece 24 occupies station 3 and the second workpiece 24 occupies station 2, a third workpiece 24 (the workpiece 24 following directly after the second workpiece 24) occupies station 1. This sort of operation continues until the operator decides to stop feeding workpieces 24 to supply ramp 26 or otherwise turns off the power to fixture 24. As to the operations performed at stations 1-6, fixture 20: a) receives, at station 1, a respective workpiece 24; b) flattens, at station 2, a center portion 50 of the respective workpiece 24; c) forms (i.e., by punching, stamping, or cutting out), at station 3, a pair of through-holes 52 in center portion 50 of the respective workpiece 24 which has been flattened; d) performs, at station 4, an initial swaging operation on each longitudinal end 34 of the respective workpiece 24; e) performs, at station 5, a finish swaging operation on each longitudinal end 34 of the respective workpiece 24 such that each end 34 of the respective workpiece 24 is configured for receiving, and for forming a crimped connection with, an electrical conductor (not shown); and f) cuts (i.e., by punching, stamping, or cutting out a portion 54 of center portion 50), at station 6, center portion 50 of the respective workpiece 24 to form two electrical terminals 22.

FIG. 2 shows schematically the forming devices 30, which can otherwise be referred to generally as stamps, punches, or cutters. Forming devices 30 are used in conjunction with main body 28 to perform one or more forming operations at forming stations 2-6. FIG. 2 shows that forming devices 30 include forming devices 30A, 30B, 30C, 30D, and 30E. Device 30A corresponds to station 2. Device 30B corresponds to station 3. Device 30C corresponds to station 4. Device 30D corresponds to station 5. Device 30E corresponds to station 6. Forming devices 30A, 30B, and 30E are spaced a greater vertical distance from their corresponding stations than forming devices 30C and 30D. This is to signify that forming devices 30A, 30B, and 30E can approach a respective workpiece 24 with vertical movement and that forming devices 30C and 30D can approach a respective workpiece with horizontal movement. Device 30A is a punch or stamp which flattens the center of the respective tube 24. FIGS. 6 and 7, for instance, show a flattened center portion 50 of workpiece 24. Device 30B cuts, punches, or stamps out two through-holes 52 in the flattened center portion 50 of the respective workpiece 24. Each hole 52 corresponds to one of two terminals 22 which are being formed by fixture 20. FIGS. 6 and 7, for instance, show two holes 52 formed in flattened center portion 50 of workpiece 24.

Forming device 30C performs an initial swaging operation on the still cylindrical, longitudinal ends 34 of the respective workpiece 24. FIG. 1 shows that forming device 30C moves horizontally, by virtue of double-arrow 56, to engage and disengage longitudinal ends 34 of a respective workpiece 24 so as to perform the initial swaging operation. “Swaging” is understood generally to refer to a metal-forming technique in which the dimensions of the item are altered using a die or dies, the die(s) being forced into or onto the item or the item being forced into or onto the die(s); further, swaging is understood to be a forging process in which metal is shaped using localized compressive forces. Forming device 30C uses a cold forging operation; alternatively, a hot or a warm forging operation can be used. Forming device 30C, as shown in FIG. 1, includes two punches, or pokers, which face each other and are moved forward and backward to engage and disengage the longitudinal ends 34 of the respective workpiece 24. Each punch of device 30C has a distal end which generally comes to a point and which engages the bore 38 of a respective longitudinal end 34 of tube/workpiece 24. During the initial swaging operation, forming device 30C (which can also be referred to as punches 30C) expands the diameter of the longitudinal ends 34 of the workpiece 24 in order to form in an initial state the entries to the crimped connection to the final electrical terminals 22. FIGS. 6 and 7, for instance, show longitudinal ends 34 having an altered shape at station 4, the altered shape corresponding to an expanded diameter at longitudinal ends 34. Longitudinal ends 34 remain round after the initial swaging step.

Forming device 30D is similar to forming device 30C and performs a finish swaging operation on the longitudinal ends 34 of the respective workpiece 24. Like forming device 30C, device 30D uses a cold forging operation; alternatively, a hot or a warm forging operation can be used. Forming device 30D, as shown in FIG. 1, includes two punches, or pokers, which face each other and are moved horizontally, by virtue of double-arrow 56, forward and backward to engage and disengage the longitudinal ends 34 of the respective workpiece 24. Each punch of device 30D has a distal end which generally comes to a point (either sharp or generally blunted) and which engages the bore 38 of a respective longitudinal end 34 of tube/workpiece 24. During the finish swaging operation, forming device 30D (which can also be referred to as punches 30D) further expands the diameter of the longitudinal ends 34 of the workpiece 24 in order to form in a finished state the entries to the crimped connection to the final electrical terminals 22; as such, the diameter of punches 30D is greater than the diameter of punches 30C. While the drawings (i.e., FIGS. 6 and 7) do not show the diameter of longitudinal ends 34 at station 5 being greater than the diameter of longitudinal ends 34 at station 4, it is understood that this is actually the case. Longitudinal ends 34 remain round after the finish swaging step. FIG. 6 shows stations 4 and 5 (and station 6) as having dowel pins 64 which aid in the manufacturing process of the present invention. Dowel pins 64 are shown as the shaded quadrants—in particular the upper right and lower left quadrants—of each hole 52; it is understood that dowel pins 64 could be positioned elsewhere, such as in the upper left and lower right quadrants of each hole 52. Dowel pins 64 are shown only in FIG. 6 but are not shown, for the sake of clarity, in the other figures.

Forming device 30E cuts, punches, or stamps out portion 54 of center portion 50 of the respective workpiece 24 to form two electrical terminals 22 from the one workpiece 24. In removing this portion 54 of center portion 50 of the respective workpiece 24, the single workpiece 24 thus becomes two pieces which are two terminals 22. After the workpiece 24 is divided so as to form the two terminals 22, terminals 22 are removed from station 6 (and thus removed from notches 46 of station 6), removed from fixture 20, and bagged. Using slide 32 to lift terminals 22 and/or a blast of air can help terminals to be removed off end of fixture 20 or otherwise removed from fixture 20. Station 6 in FIG. 7 shows two terminals 22 that have been already stamped out of workpiece 24; the wing-like feature 66 can be a depression in main body 28 which accommodates a corresponding stamp 30E for stamping out portion 54 of flattened center portion 50. FIG. 1 also shows this wing-like feature 66 at station 6, the broken lines across center portion 50 in workpiece 24 of station 6 in FIG. 1 showing portion 54 which is to be stamped out of center portion 50 to form the two terminals 22. Only FIGS. 1 and 6 show wing-like feature 66, the other figures omitting feature 66 for the sake of clarity. Station 6 in FIG. 7 shows two terminals 22, the broken lines joining the two terminals 22 showing the portion 54 stamped, punched, or cut out of flattened center portion 50 of workpiece 24.

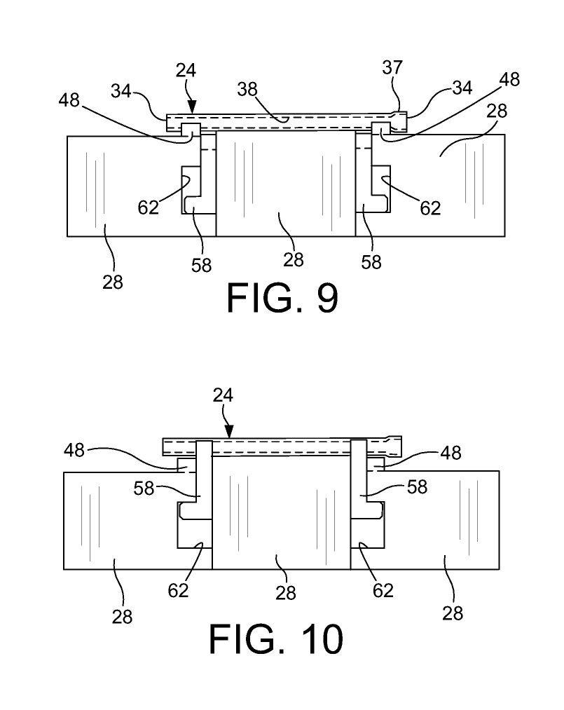

Incrementing slide 32 moves workpiece 24 incrementally from station-to-station. Stated another way, incrementing slide 32 moves each workpiece 24, one after another, sequentially forward through stations 1, 2, 3, 4, 5, and 6. Slide 32 includes two spaced-apart arms 58 (which can also be referred to as walls 58) which can be generally L-shaped and thus have a substantially vertical section and a substantially horizontal section, as shown in FIGS. 9 and 10. The vertical section of arms 58, as shown in FIGS. 6-10, run in direction of advance 40, run parallel to the upstanding walls 48 of main body 28, and can be set inwardly of and adjacent to (but not necessarily contacting) upstanding walls 48. Slide 32 defines a plurality of notches 60 formed in pairs. FIG. 8 shows that slide can include at least seven pairs of notches 60; more pairs of notches 60 could be included on slide 32. More specifically, each arm 58, on an upwardly facing surface of each arm 58, defines notches 60. Each pair of notches 60 includes one notch 60 on one arm 58 and one notch 60 on the other arm 58 of slide 32. Slide 32 is configured for the following: a) being raised to pick up a respective workpiece 24 from a respective station 1, 2, 3, 4, 5, or 6; b) picking up the respective workpiece 24, by opposing longitudinal ends 34 of the respective workpiece 24, from the respective station 1, 2, 3, 4, 5, or 6; c) moving the respective workpiece 24 forward to a subsequent station 2, 3, 4, 5, or 6 (because station 6 is the final station, the terminals 22 formed in station 6 are not moved to a subsequent forming station but are rather removed from fixture 20 as indicated below); and d) setting the respective workpiece 24 down at the subsequent station 2, 3, 4, 5, or 6. Fixture 20 performs a forming operation at the subsequent station 2, 3, 4, 5, or 6.

Each pair of notches 60 carries one workpiece 24 at a time from one station to the next station, and because slide 32 has a plurality of notch pairs 46 slide 32 can carry a plurality of workpieces 24 at one time. Slide 32 picks up, moves forward, and sets down a respective workpiece 24 using a corresponding pair of notches 46 in slide 32. While the upstanding walls 48 of main body 28 remain fixed, slide 32 can move so as to advance the workpieces 24 from station-to-station of main body 28. In so doing, slide 32, using a pair of its own notches 60, picks up a respective workpiece 24 from a corresponding pair of notches 46 at a respective station and sets down the respective workpiece 24 into a corresponding pair of notches 46 at a subsequent station. Thus, for example, when six workpieces 24 are resting in main body notch pairs 46 corresponding to the six stations 1, 2, 3, 4, 5, and 6, slide 32—moving as a single unit—can pick up all six workpieces 24 from notches 46 in main body 28 using notches 60 of slide 32 and then advance all six of the workpieces 24 forward one station (the leading workpiece 24, now having been divided into two electrical terminals 22, does not actually advance to a station, as noted above). Then, slide 32 sets five of the workpieces 24 down in the next set of notches 46 in main body 28, the finished terminals 22 not being set back down in main body notches 46. Then, slide 32 returns back to the previous set of notches 46 in main body 28 (in a direction opposite direction of advance 40) to pick up six workpieces 24 again, now to advance those workpieces 24 forward one station. Stated another way, to move the workpieces 24 from one station to the next, slide 32 lifts the copper tubing 24 (in its various shapes), advances a distance of one station, sets the tubing 24 back down into a pair of notches 46 in main body 28 for the next forming operation, and returns to the previous set of notches 46. After workpieces 24 are set down in a station, workpieces 24 are then stamped according to the forming operations described above (station 1 is not a forming station, as no stamping, punching, or cutting occurs at station 1; station 1 is, rather, a holding station). In this way, slide 32 accomplishes a generally elliptical travel path and spans a horizontal distance of only one station at a time. The internal mechanism for moving slide 32 can include air cylinders and one or more springs. For instance, during the travel path of slide 32, slide 32 can go up using air cylinders, go forward (in the direction of advance 40) using air cylinders, go down using one or more springs, and be pulled back to the prior station using air cylinders. The air cylinders and spring(s) are not shown in the drawings. FIG. 9 shows arms 58, and thus slide 32, in the up position with a workpiece 24 lifted off of main body 28. FIG. 10 shows arms 58, and thus slide 32, in the down position with the workpiece 24 placed in notches 46 of upstanding walls 48 of main body 28, arms 58 having been lowered below workpiece 24 so as to return to the home position of slide 32. As can be seen by comparing FIGS. 9 and 10, the horizontal section of arms 58 (and also the vertical sections of arms 58) move up and down in one or more cavities 62 of main body 28.

The fixture 20 can be fully automated. As such, an operator merely has to load the supply ramp 26 with copper tubing 24, provide the fixture 20 with electrical power, and monitor the operation of fixture 20. Electrical power can power, for example, devices 30A, 30B, and 30E (i.e., the punches, stamps, and/or cutters), the swage punches 30C and 30D for engagement and disengagement with the longitudinal ends 34 of the workpieces 24, and valves (not shown) for controllably providing pneumatic pressure to move incrementing slide 32 and for issuing the aforementioned air blast to remove terminals 22.

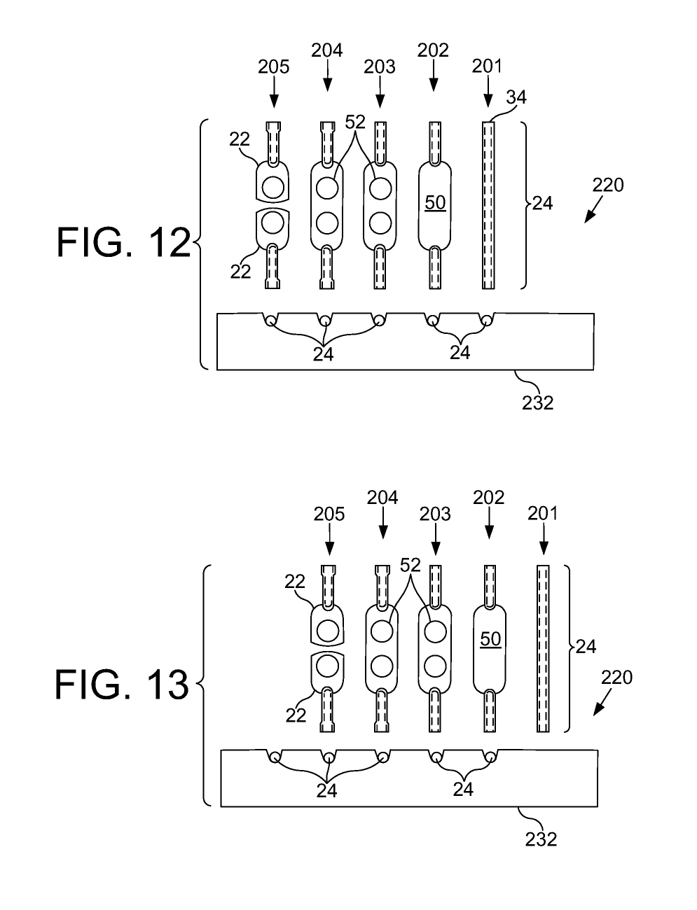

FIGS. 1, 6, 7, 8, 9, and 10 (as well as FIGS. 12, 13, and 14) show one or more workpieces 24 in one or more stages of their development into terminals 22. FIG. 1 shows six workpieces 24 in the six stations 1, 2, 3, 4, 5, and 6. Each workpiece 24 in FIG. 1, however, is shown prior to undergoing the forming step corresponding to the particular station in which the workpiece 24 currently rests. Thus, the workpiece 24 in station 2 in FIG. 1 is still shown as a cylindrical tube 24 which has not yet been flattened in center portion 50, which is the forming step that occurs at station 2. Similarly, station 3 shows a workpiece 24 which has a flattened center portion 50 but has not yet received center holes 52, which is the forming step that occurs at station 3. The same corresponding state applies to the workpieces 24 shown in FIG. 1 in stations 4, 5, and 6. Regarding FIG. 6, six workpieces 24 are shown in the six stations 1, 2, 3, 4, 5, and 6. Contrary to FIG. 1, the workpieces 24 shown in FIG. 6 have already undergone the forming step corresponding to the particular station in which the workpiece 24 currently rests. That is, the workpiece 24 in station 2 is already shown to have a flattened center portion 50, which is the forming step that occurs at station 2. Similarly, station 3 shows that the workpiece 24 has already received two holes 52, which is the forming step that occurs at station 3. The same corresponding state applies to the workpieces 24 shown in FIG. 6 in stations 4, 5, and 6. FIG. 7 shows fixture 20 of FIG. 6 but with parts broken away for the sake of clarity. The workpieces shown in FIG. 7 (as well as FIGS. 12, 13, and 14) are shown like the workpieces 24 in FIG. 6; that is, the workpieces 24 in FIG. 7 (and FIGS. 12, 13, and 14) have already received the forming step at the corresponding station. For the sake of clarity, FIG. 8 (which shows a side view of the fixture 20 of FIG. 6) does not show any workpieces in stations 1-6 but does show a workpiece loaded in supply ramp 26 and another workpiece loaded in a first pair of notches 60 in slide 32. Further, FIGS. 9 and 10 show an end view of fixture 20 with portions broken away for the sake of clarity. FIGS. 9 and 10 show workpiece 24 having only one longitudinal end 34 which has been swaged, which can occur as an option within contemplation of the present invention; but it is understood that longitudinal ends 34 as described in this embodiment are both swaged at essentially the same time.

In use, the copper tubing is precut so as to form a plurality of workpieces 24 in the form of cylindrical tubes 24. An operator loads several workpieces 24 in inlet 42 of supply ramp 26 such that the longitudinal axis 36 of each workpiece 24 is perpendicular to direction of travel 40. As workpieces 24 progress through forming stations 1-6 and are removed from fixture 20 and bagged, the operator continues to load supply ramp 26 with additional precut workpieces 24. A respective workpiece 24 is emitted from outlet 44 of supply ramp into a pair of notches 60 formed in slide 32. Slide 32 transports the respective workpiece 24 to station 1 of main body 28, lowers workpiece 24 into notches 46 of station 1 and thereby releases workpiece 24 from notches 60, travels opposite direction of advance 40, raises so as to receive a second workpiece 24 from supply ramp 26, and receives a second workpiece 24 from supply ramp 26. In raising to receive the second workpiece 24, slide 32 picks up the first workpiece 24 from station 1. Now, having received the second workpiece 24 in a pair of notches 60, slide 32 again advances a distance of one station and lowers second workpiece 24 into notches 46 of station 1. In lowering second workpiece 24 into notches 46 of station 1, slide 32—moving as a single unit—simultaneously lowers the first workpiece 24 into notches 46 of station 1. Slide thus releases first and second workpieces 24 into notches 46 of stations 1 and 2, again travels opposite direction of advance 40, raises so as to receive a third workpiece 24 from supply ramp 26, and receives a third workpiece 24 from supply ramp 26. In raise to receive the third workpiece 34, slide also picks up the first and second workpieces 24 from stations 1 and 2. This cycle continues to repeat itself, advancing workpieces through stations 1-6. Between releasing the respective workpiece in notches 46 of a station and raising so as to again pick up that same workpiece 24 after having traveled opposite direction of travel 40, the corresponding forming operation occurs at stations 2-6. As indicated above, station 2 flattens a center portion 50 of workpiece 24. Station 3 stamps two holes 52 out of center portion 50. Station 4 performs an initial swaging operation in longitudinal ends 34 of workpiece 24 and thereby increases the diameter of ends 34. Station 5 performs a finish swaging operation in longitudinal ends 34 and thereby further increases the diameter of ends 34. Station 6 stamps out a portion 54 of center portion 50 of workpiece 54 so as to form two terminals 22.

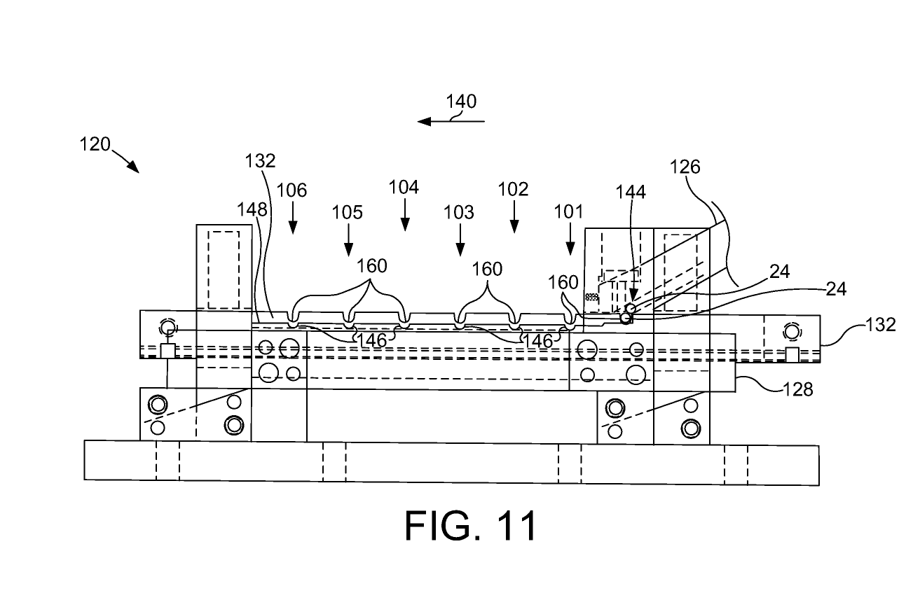

Now, additionally referring to FIG. 11, there is shown another embodiment of the electrical terminal manufacturing fixture and method of the present invention, the fixture having the reference number 120. Fixture 120 includes structure which corresponds to fixture 20. Some of those corresponding structures are labeled in FIG. 11 and are raised by 100 relative to fixture 20. Workpiece 24, however, retains its original reference number. Fixture 120 also has six stations 101, 102, 103, 104, 105, and 106, these stations corresponding to stations 1, 2, 3, 4, 5, and 6. One difference between fixtures 120 and 20 is that main body 128 has only six pairs of notches 146. Another difference is that main body 128 has a wall which is higher near supply ramp 126 than the wall of main body 28 near supply ramp 26.

Now, additionally referring to FIGS. 12-14, there is shown yet another embodiment of the electrical terminal manufacturing fixture and method of the present invention, the fixture having the reference number 220. Fixture 220 includes structure which corresponds to fixture 20. Some of those corresponding structures are labeled in FIGS. 12-14 and are raised by 200 relative to fixture 20. Workpiece 24 and its various parts and terminal 22, however, retain their original reference numbers. FIGS. 12-14 show, however, only slide 232 and workpieces 24. FIGS. 12-14 show a side view of slide 232 with longitudinal ends 34 of workpieces also shown. Further, FIGS. 12-14 also show workpieces 24 exploded from slide 232 and rotated to show a top view of workpieces 24 in their stations 201, 202, 203, 204, and 205. The difference in this embodiment, generally stated, is that at least two forming operations are performed at one of the forming stations. Thus, fixture 220 includes only stations 201, 202, 203, 204, and 205. Selected steps (performing operations) are combined at a single station 201, 202, 203, 204, or 205. The forming operations, as stated above, are as follows: a) flattening center portion 50 of a respective workpiece 24; b) forming a pair of holes 52 in center portion 50 of a respective workpiece 24 which has been flattened; c) performing an initial swaging operation on each end 34 of the respective workpiece 24; d) performing a finish swaging operation on each end 34 of the respective workpiece 24; and e) cutting the respective workpiece to form the two electrical terminals 22. FIGS. 12-14 show that, in this embodiment, the finish swaging and center cut operations are combined at a single station (as shown at station 205 in FIGS. 12-14). Alternatively, the initial and finish swaging operations at the ends 34 of the tubing 24 can be performed through the use of a two-stage swaging punch, etc. Even in this embodiment then, the general operations performed at the stations 201, 202, 203, 204, and 205 are thus the flattening of the tubing 24, forming of the holes 52, swaging of the tubing ends 34, and cutting-off the tubing 24 between the holes 52. Further, while the dowel pins shown in FIG. 6 are not shown in FIGS. 12-14 for the sake of clarity, it is understood that the fixture 220 and method of this embodiment can include such dowel pins.

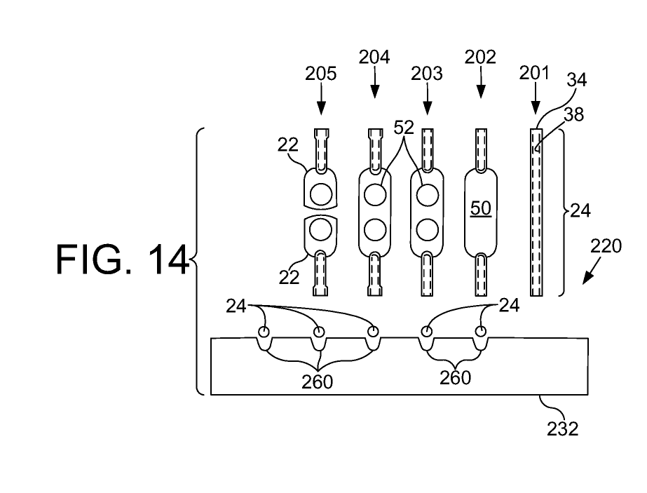

Similar, however, to the prior embodiments of the invention, the operation of slide 232 is shown in FIGS. 12-14. FIG. 12 shows slide 232 having moved up and been loaded with workpieces 24. FIG. 13 shows slide 232 still in the up position and having advanced one station forward. FIG. 14 shows slide 232 having moved to a down position and thus having released workpieces 24 in notches 246 of main body 228; forming devices 30 then perform their corresponding actions at this time. Notches 246 and main body 228 are not shown in FIGS. 12-14.

The present invention further provides a method of manufacturing a plurality of electrical terminals 22. The method includes the steps of providing an electrical terminal manufacturing fixture 20 which includes a main body 28 defining a plurality of stations 1, 2, 3, 4, 5, and 6; loading fixture 20 with a plurality of metal workpieces 24 each formed as a tube; and moving workpieces 24, one after another, sequentially forward through stations 1, 2, 3, 4, 5, and 6 and thereby transforming each workpiece 24 into two electrical terminals 22. Each workpiece 24 has a longitudinal axis 36, and main body 28 defines a direction of advance 40 in which workpieces 24 are moved forward through stations 1, 2, 3, 4, 5, and 6, longitudinal axis of each workpiece 24 being perpendicular to direction of advance 40 when workpieces 24 are moved respectively forward through stations 1, 2, 3, 4, 5, and 6. Fixture 20 includes supply ramp 26 which is loaded with workpieces 24 and feeds each workpiece 24 via gravity, indirectly, to station 1. Fixture 20 includes an incremental slide 32. The step of moving uses incremental slide 32 to move each workpiece 24, one after another, sequentially forward through stations 1, 2, 3, 4, 5, and 6. The method can further include the following steps: raising slide 32 to pick up a respective workpiece 24 from a respective station 1, 2, 3, 4, 5, or 6; picking up, using slide 32, the respective workpiece 24 by opposing longitudinal ends 34 of the respective workpiece 24 from the respective station 1, 2, 3, 4, 5, or 6; moving the respective workpiece 24 forward, using slide 32, to a subsequent station 2, 3, 4, 5, or 6; setting the respective workpiece down, using slide 32, at the subsequent station 2, 3, 4, 5, or 6; and performing a forming operation at the subsequent station 2, 3, 4, 5, or 6. Main body 28 defines a pair of notches 46 at each station 1, 2, 3, 4, 5, and 6, the respective workpiece 24 being picked up by slide 32 from a corresponding pair of notches 46 at the respective station 1, 2, 3, 4, 5, or 6, the respective workpiece being set down by slide 32 into a corresponding pair of notches 46 at the subsequent station 2, 3, 4, 5, or 6. Slide 32 defines a plurality of notches 60 formed in pairs, slide 32 picking up, moving forward, and setting down the respective workpiece 24 using a corresponding pair of notches 60 in slide 32. The method can further includes the following steps: receiving, at station 1, a respective workpiece 24; flattening, at station 2, center portion 50 of the respective workpiece 24; forming, at station 3, a pair of holes 52 in center portion 50 of the respective workpiece 24 which has been flattened; performing, at station 4, an initial swaging operation on each end 34 of the respective workpiece 24; performing, at station 5, a finish swaging operation on each end 34 of the respective workpiece 24; and cutting, at station 6, the center portion 50 of the respective workpiece 24 to form two electrical terminals 22. A plurality of forming operations can be respectively performed at corresponding ones of stations 201, 202, 203, 204, and 204, the forming operations including a) flattening a center portion 250 of a respective workpiece 24, b) forming a pair of holes 252 in center portion 250 of the respective workpiece 24 which has been flattened, c) performing an initial swaging operation on each end 234 of the respective workpiece 24, d) performing a finish swaging operation on each end 234 of the respective workpiece 24, and e) cutting the respective workpiece 24 to form two electrical terminals 22, at least two of these forming operations being performed at one of the stations 202, 203, 204, and 205. The method of the present invention can further include the step of feeding continuously workpieces 24 through fixture 20.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of manufacturing a plurality of electrical terminals, said method comprising the steps of:
providing an electrical terminal manufacturing fixture which includes a main body defining a plurality of stations;
loading said fixture with a plurality of metal workpieces each formed as a tube; and
moving said workpieces, one after another, sequentially forward through said stations and thereby transforming each said workpiece into two of the electrical terminals.

2. The method of claim 1, wherein each said workpiece has a longitudinal axis and said main body defines a direction of advance in which said workpieces are moved forward through said stations, said longitudinal axis of each said workpiece being perpendicular to said direction of advance when said workpieces are moved respectively forward through said stations.

3. The method of claim 2, wherein said fixture includes a supply ramp which is loaded with said workpieces and feeds each said workpiece via gravity, indirectly, to a first one of said plurality of stations.

4. The method of claim 2, wherein said fixture includes an incremental slide, said step of moving using said incremental slide to move each said workpiece, one after another, sequentially forward through said stations.

5. The method of claim 4, further comprising the steps of:
raising said slide to pick up a respective said workpiece from a respective said station;
picking up, using said slide, said respective workpiece by opposing longitudinal ends of said respective workpiece from said respective station;
moving said respective workpiece forward, using said slide, to a subsequent said station;
setting said respective workpiece down, using said slide, at said subsequent station;
performing a forming operation at said subsequent station.

6. The method of claim 5, wherein said main body defines a pair of notches at each said station, said respective workpiece being picked up by said slide from a corresponding said pair of notches at said respective station, said respective workpiece being set down by said slide into a corresponding said pair of notches at said subsequent station.

7. The method of claim 5, wherein said slide defines a plurality of notches formed in pairs, said slide picking up, moving forward, and setting down said respective workpiece using a corresponding said pair of notches in said slide.

8. The method of claim 2, further comprising the steps of:
receiving, at a first said station, a respective said workpiece;
flattening, at a second said station, a center portion of said respective workpiece;
forming, at a third said station, a pair of holes in said center portion of said respective workpiece which has been flattened;
performing, at a fourth said station, an initial swaging operation on each end of said respective workpiece;
performing, at a fifth said station, a finish swaging operation on each said end of said respective workpiece; and
cutting, at a sixth said station, said center portion of said respective workpiece to form said two electrical terminals.

9. The method of claim 2, wherein a plurality of forming operations are respectively performed at corresponding ones of said stations, said forming operations including a) flattening a center portion of a respective said workpiece, b) forming a pair of holes in said center portion of said respective workpiece which has been flattened, c) performing an initial swaging operation on each end of said respective workpiece, d) performing a finish swaging operation on each said end of said respective workpiece, and e) cutting said respective workpiece to form said two electrical terminals, at least two of said forming operations being performed at one of said stations.

10. The method of claim 2, further comprising the step of feeding continuously said workpieces through said fixture.

11. An electrical terminal manufacturing fixture for manufacturing a plurality of electrical terminals, said fixture comprising:
a main body defining a plurality of stations, the fixture configured for being loaded with a plurality of metal workpieces each formed as a tube and for moving said workpieces, one after another, sequentially forward through said stations and thereby transforming each said workpiece into two of the electrical terminals.

12. The electrical terminal manufacturing fixture of claim 11, wherein said main body defines a direction of advance in which said workpieces are moved forward through said stations, said direction of advance being perpendicular to a longitudinal axis of each said workpiece when said workpieces are moved respectively forward through said stations.

13. The electrical terminal manufacturing fixture of claim 12, further comprising a supply ramp which is configured for being loaded with said workpieces and for feeding each said workpiece via gravity, indirectly, to a first one of said plurality of stations

14. The electrical terminal manufacturing fixture of claim 12, further comprising an incremental slide configured for moving each said workpiece, one after another, sequentially forward through said stations.

15. The electrical terminal manufacturing fixture of claim 14, wherein said slide is configured for:
a) being raised to pick up a respective said workpiece from a respective said station,
b) picking up said respective workpiece by opposing longitudinal ends of said respective workpiece from said respective station,
c) moving said respective workpiece forward to a subsequent said station, and
d) setting said respective workpiece down at said subsequent station,
wherein the fixture is configured for performing a forming operation at said subsequent station.

16. The electrical terminal manufacturing fixture of claim 15, wherein said main body defines a pair of notches at each said station, said slide being configured for picking up said respective workpiece from a corresponding said pair of notches at said respective station and for setting down said respective workpiece into a corresponding said pair of notches at said subsequent station.

17. The electrical terminal manufacturing fixture of claim 15, wherein said slide defines a plurality of notches formed in pairs, said slide being configured for picking up, moving forward, and setting down said respective workpiece using a corresponding said pair of notches in said slide.

18. The electrical terminal manufacturing fixture of claim 12, wherein the fixture is configured for:
a) receiving, at a first said station, a respective said workpiece,
b) flattening, at a second said station, a center portion of said respective workpiece,
c) forming, at a third said station, a pair of holes in said center portion of said respective workpiece which has been flattened,
d) performing, at a fourth said station, an initial swaging operation on each end of said respective workpiece,
e) performing, at a fifth said station, a finish swaging operation on each said end of said respective workpiece, and
f) cutting, at a sixth said station, said center portion of said respective workpiece to form said two electrical terminals.

19. The electrical terminal manufacturing fixture of claim 12, wherein the fixture is configured for performing at corresponding ones of said stations respectively a plurality of forming operations including:
a) flattening a center portion of a respective said workpiece,
b) forming a pair of holes in said center portion of said respective workpiece which has been flattened,
c) performing an initial swaging operation on each end of said respective workpiece,
d) performing a finish swaging operation on each said end of said respective workpiece, and
e) cutting said respective workpiece to form said two electrical terminals, wherein at least two of said forming operations are performed at one of said stations.

20. The electrical terminal manufacturing fixture of claim 12, wherein the fixture is configured for continuously feeding said workpieces therethrough.
